(19) United States
(12) Patent Application Publication
(10) Pub. No.: US 2021/0192051 A1
(43) Pub. Date: Jun. 24, 2021

(54) SECURE KEYS EXCHANGES

(71) Applicant: HEWLETT-PACKARD DEVELOPMENT COMPANY, L.P., SPRING, TX (US)

(72) Inventors: JAMES ROBERT WALDRON, SPRING, TX (US); ADRIAN BALDWIN, BRISTOL (GB); RICK BRAMLEY, MANSFIELD, MA (US)

(21) Appl. No.: 16/755,820

(22) PCT Filed: Jan. 29, 2018
(86) PCT No.: PCT/US2018/015680

§ 371 Date: Apr. 13, 2020

(51) Int. Cl. G06F 21/57; H04L 9/32; G06F 21/60

(52) U.S. Cl. CPC G06F 21/575; G06F 21/602; H04L 9/3263

(57) ABSTRACT

A method, in an example, for secure key exchange in a platform, the method comprises checking a value of parameter via a platform hardware initialisation device to determine a status of an agent, generating at least one symmetric cryptographic key, encrypting the at least one symmetric cryptographic key using a public cryptographic key, generating a variable representing the encrypted at least one symmetric cryptographic key, and enabling access to the variable from the agent via the platform hardware initialisation device.

### BACKGROUND

Platform integrity can be assured using secure processing devices such as Trusted Platform Modules (TPMs) for example. TPMs can be used to generate and store cryptographic keys, passwords, and/or digital certificates for example, and they can form a root of trust to ensure that a platform boot process executes using a trusted configuration.

### BRIEF DESCRIPTION OF THE DRAWINGS

Various features of certain examples will be apparent from the detailed description which follows, taken in conjunction with the accompanying drawings, which together illustrate, by way of example only, a number of features, wherein:

FIG. 1 is a schematic representation of a platform to perform secure key exchanges according to an example;

FIG. 2 is a schematic representation of a process flow for trust establishment in a platform for performing secure key exchanges according to an example;

FIG. 3 is a schematic representation of a process flow for a key exchange in a platform according to an example; and

FIG. 4 is a schematic representation of a processor associated with a memory in a platform for performing secure key exchanges according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

According to an example, platform security can be extended into an OS using an agent (within the OS) that leverages secure communications with components within the platform.

One such component can be in the form of a subordinate control device, or extra controller. Such a device is subordinate inasmuch as it is provided to control the function of a peripheral device, such as a keyboard for example. It can have a low bandwidth communication link to a main processor of a platform and does not share a memory with the main processor.

According to an example, to use a platform's security properties to help secure OS functions, a process running within the platform and an OS agent can securely communicate by using a TPM (or similar) to share a cryptographic key between the OS Agent and a process running within the extra controller (EC). This can enable secure on-going communications between the OS agent and the EC, allowing a heartbeat and/or other security information to be secured.

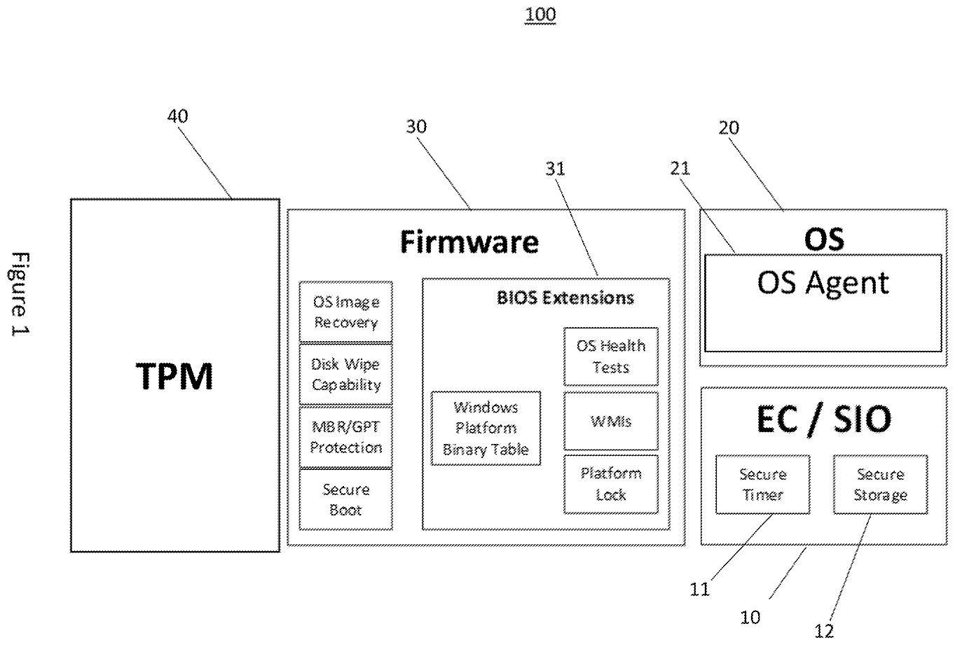

FIG. 1 is a schematic representation of a platform to perform secure key exchanges according to an example. Platform 100 comprises an EC 10, which can comprise a secure timer 11 and storage 12. An OS 20 comprises an OS agent 21. Firmware 30 can comprise a set of firmware extensions 31, and a secure cryptoprocessor 40 is provided. In an example, secure cryptoprocessor 40 can be a trusted platform module (TPM).

In overview, according to an example, an initial phase is used to establish trust. Accordingly, an OS based agent is registered with instructions executing in the EC. At this stage, the OS agent generates a TPM based cryptographic key pair and the EC registers a public key from this key pair. The OS agent can initialise during a platform boot process, where the agent performs a key exchange to obtain a symmetric keyed-hash message authentication code (HMAC) key and/or an advanced encryption standard (AES) encryption key. This enables the OS agent to securely communicate with the EC. The trust establishment and initialisation stages enable key exchange between the EC and the OS agent based on being protected by the TPM, which enables secure communications.

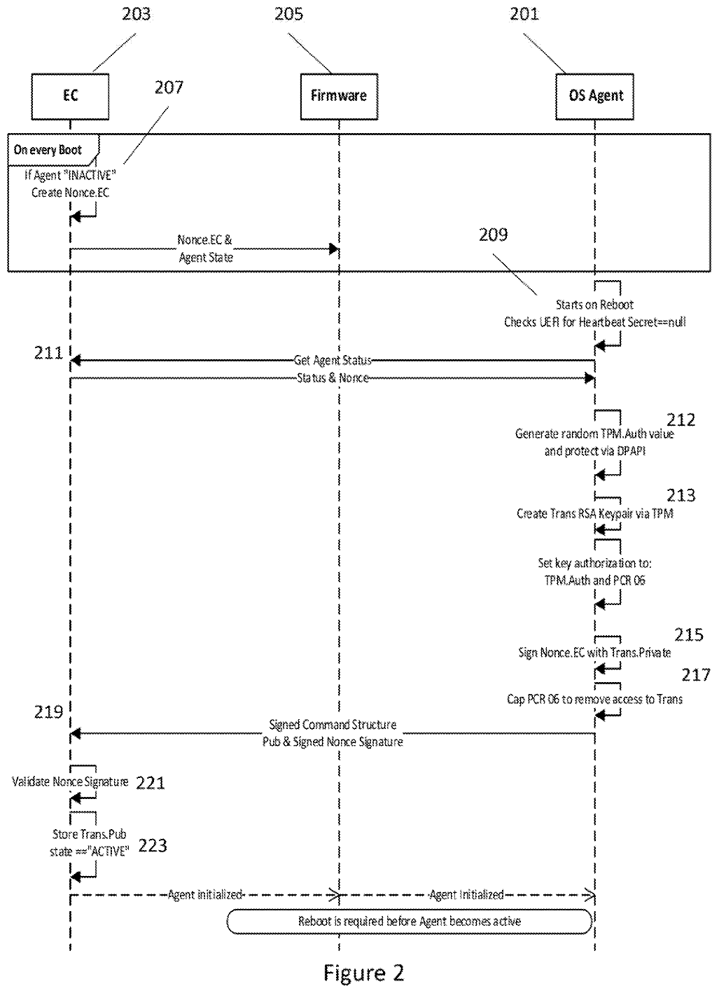

FIG. 2 is a schematic representation of a process flow for trust establishment in a platform for performing secure key exchanges according to an example. In a platform comprising an OS agent 101, when the OS Agent 201 is to be enabled the EC 203 receives a management command and the EC 203 records a state of “agent inactive”. When in this state a nonce is generated at start up (207).

In an example, the OS agent 201 is started early in the platform OS boot chain, either as a service or through the Windows WPBT mechanism. As it starts, it looks for a key package (for example via a Unified Extensible Firmware Interface (UEFI) variable, 209) and if that is not available it grabs and checks the status flag (211) from the EC 203 and (if it exists) the nonce generated at 207 from the EC. In an example, this can be performed via a call to the platform firmware 205.

Once this happens the OS Agent 201 can create (213) a cryptographic key pair (Transport.Pub and Transport.Private Key Pair) within a TPM of the platform using a random authorisation code (212) to control access. In an example, the random authorisation value 212 can be stored within a protected system, for example using the Windows DPAPI using a repeatable piece of entropy that is unique and unpredictable on each device. In an example, the TPM key is created with a policy linking it to the state of a platform configuration register (PCR) within the TPM.

The OS Agent 201 signs the nonce with its private key (215) and then prevents anyone else using the key by extending the PCR (217). The OS Agent 201 can then transmit (219) the encrypted nonce and the public key (Transport.Pub Key) back to the EC 203 via the firmware 205. In an example, the EC 103 can check (221) that the correct nonce was returned by decrypting it using the Transport.Pub key. If correct, the EC 203 changes its state>to “active” (223) and saves the Transport.Pub key.

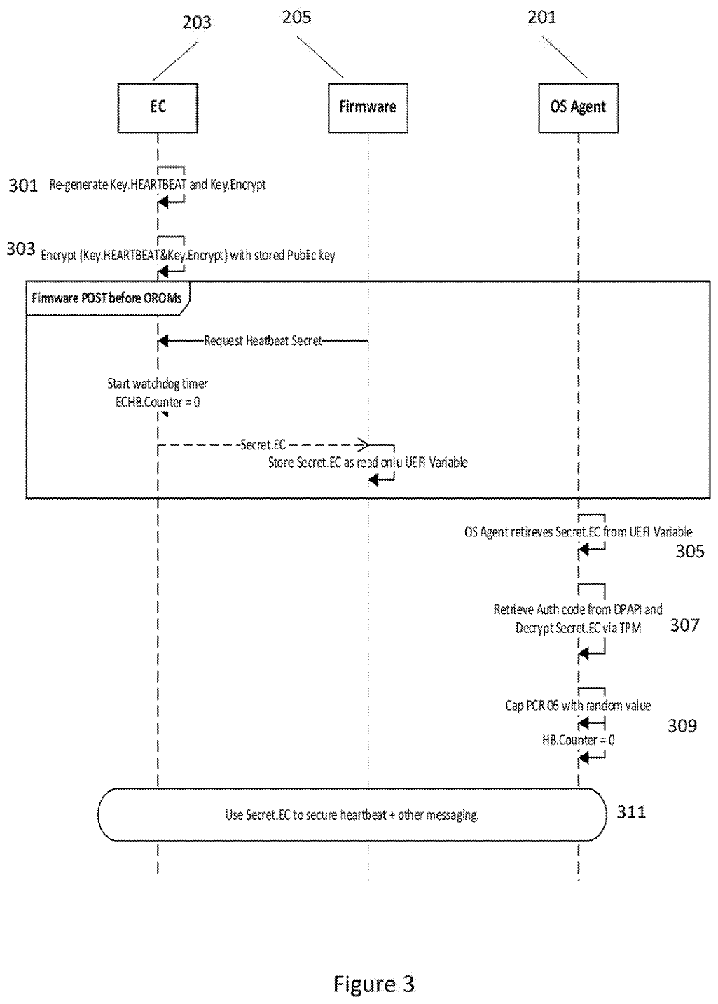

FIG. 3 is a schematic representation of a process flow for a key exchange in a platform according to an example. At platform boot, once the Transport key has been saved by the EC 203 and the state changed to active the EC 203 generates at least one new symmetric cryptographic key. In the example of FIG. 2, it generates (301) (first and second) symmetric cryptographic keys (the HMAC key (Key.Heartbeat) and possibly an AES encryption key (Key.Encrypt)). These keys are encrypted (303) using the Transport.Pub key. They are passed to the firmware 205 which makes them available to the OS agent 201 as a UEFI variable.

As the OS Agent 201 starts it reads (305) this UEFI variable from firmware 205 and therefore knows to take control of the TPM based key; firstly, by regenerating (307) the authorization value and then using this to unlock the key within the TPM. In an example, the OS Agent 201 will then load the Transport key pair into the TPM 40 and use it to decrypt the key package retrieved from the UEFI variable. The OS Agent 201 then extends (309) the OEM PCR and clears the key handle so that the key can no longer be used. The OS Agent 201 can then use the recovered HMAC and AES key to securely communicate 311 with the EC 203.

Therefore, according to an example, there is provided a method for exchanging keys between the EC 203 (or additional platform component) and a component 201 that runs automatically within an OS 20 of a platform 100. In an example, during registration the OS Agent can use a TPM identity key to certify that the Transport key was created within the TPM.

Furthermore, in an example, timers can be used between events within the system to regulate later use of keys. For example:
a. The time between boot and the first use of a communication secured by one to the symmetric keys could be regulated in case the agent fails to pick up the key properly;
b. The time between boot and picking up the status and accepting the signed nonce could be minimized to regulate when registration can take place to a freshly booted device.

Examples in the present disclosure can be provided as methods, systems or machine-readable instructions. Such machine-readable instructions may be included on a computer readable storage medium (including but not limited to disc storage, CD-ROM, optical storage, etc) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus (for example, EC 203) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

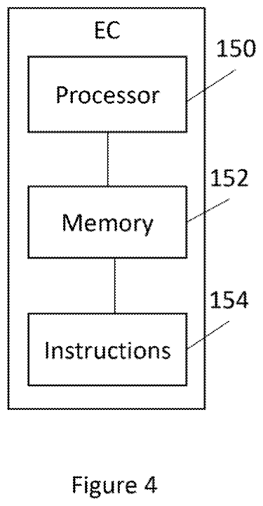

FIG. 4 is a schematic representation of a processor associated with a memory in a platform for performing secure key exchanges according to an example. In the example of FIG. 4, the processor and memory can be part of the EC 10. The memory 152 comprises computer readable instructions 154 which are executable by the processor 150. The instructions 154 comprise instructions to: retrieve encrypted first and second symmetric cryptographic keys from a platform hardware initialisation device; retrieve an authorisation code from the platform hardware initialisation device; and decrypt the encrypted first and second symmetric cryptographic keys using the authorisation code. The instructions 154 can further comprise instructions to check a status of a platform agent via the platform hardware initialisation device; monitor a period of time between platform boot and first use of a communication secured by one of the symmetric keys; reject use of one of the symmetric keys in the event that the monitored period of time exceeds a predetermined threshold value; monitor time between platform boot, retrieving the status and accepting a signed nonce; regulate when registration can take place on a freshly booted device in the event that the monitored time exceeds a predetermined threshold value; and attest to the provenance of a cryptographic key using an identity key.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for secure key exchange in a platform, the method comprising:
checking a value of parameter via a platform hardware initialisation device to determine a status of an agent;
generating at least one symmetric cryptographic key;
encrypting the at least one symmetric cryptographic key using a public cryptographic key;
generating a variable representing the encrypted at least one symmetric cryptographic key; and
enabling access to the variable from the agent via the platform hardware initialisation device.

2. The method as claimed in claim 1, further comprising:
generating the at least one symmetric cryptographic key using a random authorisation code seeded from a unique and unpredictable platform dependent value.

3. The method as claimed in claim 2, further comprising:
retrieving the encrypted at least one symmetric cryptographic key from the platform hardware initialisation device;
retrieving an authorisation code; and
using the authorisation code to unlock a private cryptographic key stored in a secure cryptoprocessor of the platform.

4. The method as claimed in claim 3, further comprising:
decrypting the encrypted at least one symmetric cryptographic key using the private cryptographic key.

5. The method as claimed in claim 1, further comprising:
generating, at subordinate control device of the platform, a nonce,
signing the nonce using the public cryptographic key; and
recording the public cryptographic key in the subordinate control device of the platform.

6. An apparatus, comprising a processor and a memory, the processor to:
register a public cryptographic key received from a platform hardware initialisation device;
modify a state of a subordinate control device stored in the memory;
generate a symmetric cryptographic key; and
encrypt the symmetric cryptographic key using the public cryptographic key.

7. The apparatus as claimed in claim 6, further comprising an agent to:
retrieve a variable from the platform hardware initialisation device representing the encrypted symmetric cryptographic key.

8. The apparatus as claimed in claim 7, the agent further to:
generate a cryptographic key pair comprising the public cryptographic key and a corresponding private key secured in a secure cryptoprocessor of the platform using a random authorisation code.

9. The apparatus as claimed in claim 7, the agent further to:
retrieve the encrypted symmetric cryptographic key from the platform hardware initialisation device;
retrieve an authorisation code; and
decrypt the encrypted symmetric cryptographic key using the private key protected by the authorisation code and secure cryptoprocessor of the platform.

10. The apparatus as claimed in claim 7, the agent further to:
lock the private cryptographic key after use by extending a platform configuration register.

11. A non-transitory machine-readable storage medium encoded with instructions executable by a processor in a platform to enable secure key exchange between an agent and a subordinate control device of the platform, the machine-readable storage medium comprising instructions to:
retrieve an encrypted symmetric cryptographic key from a platform hardware initialisation device;
retrieve an authorisation code; and
unlock a private cryptographic key stored in a secure cryptoprocessor of the platform using the authorisation code.

12. The non-transitory machine-readable storage medium as claimed in claim 11, further encoded with instructions to:
decrypt the encrypted symmetric cryptographic key using the private cryptographic key.

13. The non-transitory machine-readable storage medium as claimed in clam 11, further encoded with instructions to:
monitor a period of time between a platform boot and a first use of a communication secured by the symmetric key.

14. The non-transitory machine-readable storage medium in claim 13, further encoded with instructions to:
reject a use of the symmetric key in the event that the monitored period of time exceeds a predetermined threshold value.

15. The non-transitory machine-readable storage medium as claimed in claim 11, further encoded with instructions to:
monitor time between a platform boot, retrieving the status, and accepting a signed nonce; and
regulate when registration is to take place on a freshly booted device in the event that the monitored time exceeds a predetermined threshold value.
